(19) United States
(12) Patent Application Publication
(10) Pub. No.: US 2012/0209681 A1
(43) Pub. Date: Aug. 16, 2012

(54) Integrated Marketing Software System

(76) Inventor: Gathan Anderson, Milwaukee, WI (US)

(21) Appl. No.: 13/396,564

(22) Filed: Feb. 14, 2012

Related U.S. Application Data
(60) Provisional application No. 61/442,360, filed on Feb. 14, 2011.

(51) Int. Cl. G06Q 30/02

(52) U.S. Cl. 705/14.23

(57) ABSTRACT

The present invention is an integrated marketing RESPA-compliant software system that enables sellers and lenders quickly sell homes that otherwise languish on the market and integrates credits for the purchase of automobiles with home financing. This system integrates resources of participating lenders, real estate professionals and sellers to maximize the price buyers are willing to pay in a stagnant market because a buyer's immediate needs are met. The system is a selling tool that helps sellers ultimately net higher prices by allowing buyers to achieve more favorable auto financing rates.

The system allows home sellers and banks with foreclosure inventories the opportunity to offer competitive inducements to a specific segment of buyers attracted to lenders.

### CLAIM OF PRIORITY

Cross-Reference to Related Applications. This application claims priority to U.S. Provisional Application No. 61/442,360 filed on Feb. 14, 2011 and U.S. Application No. 13/372,449 filed on Feb. 13, 2012.

### FIELD OF INVENTION

The present invention relates to the field of marketing software, and specifically to marketing software that integrates marketing resources of participating lenders, real estate professionals and sellers.

### BRIEF DESCRIPTION OF THE DRAWINGS

FIG. 1 illustrates an exemplary embodiment of a user interface employing integrated marketing software system.

### BACKGROUND

Due to large inventories of foreclosed properties and more stringent controls over mortgage lending, residential home sellers are facing unprecedented competition in selling their homes. Overall, studies indicate that buyers are advised to pay and will higher prices for homes in good condition because new home buyers are generally cash-strapped.

Lack of cash flow after purchasing a new home is an acknowledged concern, which often leads buyers to purchase homes with conditions and design choices that mirror their own tastes.

Many buyers defer purchasing a new car until after a new home purchase because the purchase will significantly impact their Fair Isaac Corporation (FICO) score and the purchase price of the home that they may qualify.

The role of an asset manager is to liquidate foreclosed bank assets fast and for the highest amount allowable by current market conditions. Asset managers are rewarded with bonuses.

The listing agent is motivated to sell the property quickly to reduce overhead. In order to sell the property quickly, agents may undervalue the property, and, in return, they are rewarded from the bank with repeat business. BPO agents are not appraisers. If the appraised mortgage of a property was $100,000 before foreclosure, why is it worth $25,000 now? The answer is because it benefits BPO agents and asset managers and reduces the banks' overall liabilities.

Short sales are designed to reduce mortgages and quickly sell properties on the verge of foreclosure with a reduced cost to the bank. A mortgagor in default of his mortgage or in the process of selling his/her home requests the bank to accept a payoff amount for less than what is owed. During this process, the owner gives permission for the short sale specialist to negotiate with the bank to accept a reduced mortgage amount. An amount is agreed upon with the condition that the seller receive no proceeds from the sale and a quick escrow.

Some short sale specialists are preying on owners who are in financial trouble and lack a clear understanding of the process and their options. The specialist negotiates a price with the bank to determine their bottom line. Once a sales contract is accepted by the bank, the specialist continues to market and procures a buyer for the property at a higher price. Through a contract reassignment, the specialist is able to profit from the difference. The short sale specialist usually gains at least $20,000 from the sale. This happens every day, to most banks all across the nation.

It is desirable to develop a system that enables a home purchaser to obtain reliable transportation during the same period of time that they are purchasing a home.

It is desirable to develop a system in pursuant to which a home seller can provide a powerful incentive to a buyer to purchase their home.

It is further desirable to develop a system to give non-delinquent sellers a strong marketing option.

It is desirable to develop a system that utilizes both the experience rating criteria of the automobile industry with that of the home lending industry to provide purchasers with the ability to make coincident home and automobile purchases.

It is desirable to develop a system that facilitates the goal of liquidating foreclosures and overstock automobiles.

It is desirable to develop a system which saves money, provides jobs and moves inventory.

It is desirable to develop a system which is the purchasing option of the future for a new home and a new car.

### TERMS OF ART

As used herein, the term “allocated automobile credit value” means the value associated with an offer event which represents an amount a user is actually or hypothetically credited for an automobile purchase.

As used herein, the term “distributed computer hardware apparatus” means a computer apparatus having multiple hardware and software components.

As used herein, the term “listing search processor” means a processor which matches a user search record object with real estate listing record objects.

As used herein, the term “minimum acceptable offer” means the lowest price value seller is willing to sell the home for which triggers an offer event.

As used herein, the term “quasi-unique identifying data” means data used to create object specific to a user or transaction.

As used herein, the term “record object” means a data structure, object or record containing data.

As used herein, the term “real estate offer event object” means a record object having a data value which triggers the display of an allocated automobile credit value.

As used herein, the term “user search criteria” means values input by a user and may include but are not limited to number of bedroom, number of bathrooms, price range, location and square footage.

As used herein, the term “user search record object” means a data structure, object or record containing data from user search criteria.

### SUMMARY OF THE INVENTION

The present invention is an integrated marketing RESPA-compliant software system that enables sellers and lenders quickly sell homes that otherwise languish on the market and integrates credits for the purchase of automobiles with home financing. This system integrates marketing resources of participating lenders, real estate professionals and sellers to maximize the price buyers are willing to pay in a stagnant home market because immediate needs of the buyer are met. The system is a selling tool that helps sellers ultimately net higher prices for their property because it allows buyers to achieve more favorable auto financing rates.

This system will be promoted by home lenders and automobile financing companies who want to tap into a segment of qualified buyers who are obtaining loans for multiple major purchases. The system allows home sellers and banks with foreclosure inventories the opportunity to offer competitive inducements to a specific segment of buyers attracted to lenders.

### DETAILED DESCRIPTION OF INVENTION

For the purpose of promoting an understanding of the present invention, references are made in the text to exemplary embodiments of integrated marketing software, only some of which are described herein. It should be understood that no limitations on the scope of the invention are intended by describing these exemplary embodiments. One of ordinary skill in the art will readily appreciate that alternate but functionally equivalent components and devices may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

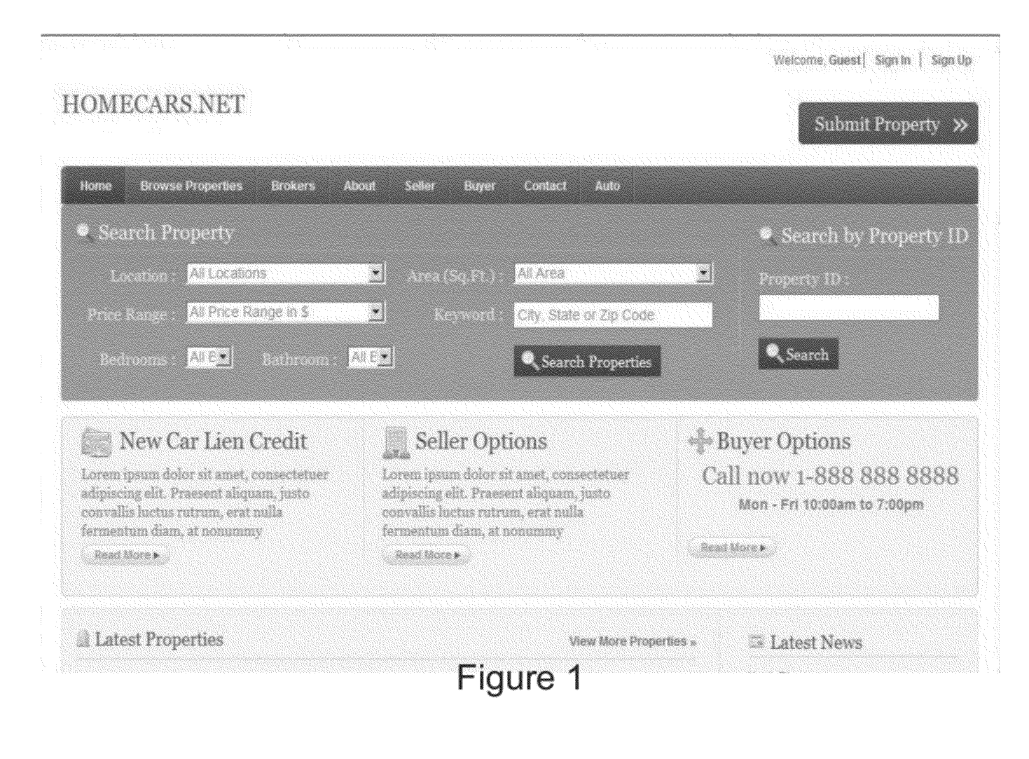

FIG. 1 illustrates an exemplary embodiment of a user interface employing integrated marketing software system. Buyers in the market for real estate property may browse properties available through integrated marketing software system based on location, price range, living area, number of bathrooms, number of bedrooms or other search parameters, such as city, state, zip code or type of property. Users may also browse recently added properties.

Each property listed with the system receives a unique property ID number. The unique property ID number allows potential buyers to quickly find a specific property and sellers to log in and access their profile information to manage the selling of the property.

Users may also search for brokers or agents under the “Brokers” tab. Brokers may be listed by number of properties listed, alphabetically or by a preferred status. Brokers and agents may choose to provide contact information that users of the system may contact the broker or agent directly. For example, a broker or agent may list a phone number, email address or other preferred contact to receive communication from users. Brokers and agents may also list their website address.

Users may also look for a car using user interface. Cars shown on the user interface are available for purchase using New Car Lien Credit.

Sellers may also list properties for sale using user interface, even if not represented. By creating an account, sellers can submit pictures and details of properties offered for sale or rent.

The exemplary embodiment shown in FIG. 1 also includes information about the New Car Lien Credit, and a user may choose to select that option to find out more information. The New Car Lien Credit allows the addition of a new vehicle to the sale of a residential property.

For example, subject property A's listed sales price is $150,000 and has been on the market for 6 months. The market analysis done by the listing broker showed that neighboring properties' prices has dropped $40,000 to $60,000 due to the number of foreclosure sales in the area. Seller informs Broker that they will accept any offer over $120,000, but want to continue marketing the property at $150,000. Broker receives offer on property for $125,000 and seller accepts. Seller loses $25,000 in much needed capital.

To help stabilize the value of a home, however, seller may list his home for the purchase price of $150,000 with $20,000 being given as a New Car Lien Credit to ABC Auto Dealer. This credit will be given to any qualified buyer. This incentive was marketed with the property, which made it very attractive to buyers. Seller received a full price offer to purchase immediately. In return, the buyer received a house and a new car at closing. The Car Lien Credit for the car came out of the seller's proceeds and in no way affected the appraised value of the property. Seller was able to deduct the $20,000 credit given to buyer on his personal taxes. Seller received full price for his property.

In the present embodiment, marketing software system may include a plurality of lenders. A user may apply for a loan from the plurality of lenders. Upon completion of the transaction, a seller will pay a listing fee using a payment process interface.

A HUD-1 Settlement Statement prepared at closing for the above situation will reflect the New Car Lien Credit and show a Purchase Price of $150,000 with a New Car Lien Credit made out to ABC Auto Dealer in the amount of $20,000. This amount is deducted from seller's proceeds that will be given to buyer at closing. The automobile is paid in full at closing with no concessions.

In addition to linking automobile sales with home sales, sellers may be able to find contractors and appraisers to perform an Increase In Value Analysis (IIVA). An estimated repair cost to increase the value of the home over the existing delinquent mortgage amount would be provided, and that cost of upgrading the property above market value will be added to the purchase price and marketed to potential buyers and investors. In turn, only when the property is purchased will contractors be paid and work to begin. This allows buyers to choose what they would like to upgrade on the property and justifies the pay back of the delinquent mortgage amounts in full.

This option will also incorporate local area businesses in the marketing of foreclosures. This option will allow those businesses to promote their goods and services. It will allow for the average buyer to get options similar to those offered to those who purchase new construction homes in which the builder adds upgrades or appliances to the sale. This approach expands options for selling older housing inventory. Home buyers that need appliances, furniture and smaller items such a lawn mowers or snow blowers can have these things can be added to the sales price of a property.

For example, a property was purchased for $115,000.00. The foreclosed delinquent mortgage amount for this property was $85,000.00. After conducting the Increase In Value Analysis report by American licensed contractors, repair costs totaled $10,000. Buyer picked furniture and appliances from a list of approved vendors and choose American Furniture in which seller was able to fully furnish the home at the cost of $5000.00 dollars. Seller needed lawn mower and additional products from Wal-Mart, for an additional $1000.00. All these expenses where paid at closing and within the scope of appraised value.

Additionally, banks could use the right of redemption period to offer the seller a second chance to get their property back by land contract. Land contracts are not credit driven. Banks could easily adjust the terms of existing mortgages into land contracts in which the full amount, including interest and penalties, is paid back by the seller.

For example, Seller owes the bank $50,000. Seller owes an additional $10,000 dollars for late payments and attorney fees. This brings the total to $60,000 dollars owed to the bank. A land contract for $60,000 over a 30 year fixed term would allow for a monthly payment of $166.57 a month, at 20 year fixed it would be $250.00 a month and at 10 years, it would be $500.00 a month. These are low amounts that will enable sellers out of financial trouble and allow them to keep their homes as well as maintain market price without any reduction.

The land contract option would also be attractive to local area investors because of the lowered upfront acquisition costs. The investor could focus their limited budgets to address needed repairs or allow them to grow their portfolios at faster rates.

Integrated marketing software system may also be configured to provide users with information pertaining to a Lease Option Plan (LOP), including contact information for banks, brokers, buyers and sellers who may be interested in entering an LOP. Under a Lease Option Plan (LOP), the seller releases rights to the property over to the bank during the redemption period. The mortgage is frozen with the seller's knowledge that property will be sold once a buyer is found. The seller is given permission by the bank to remain in the property until the sale. The only condition is that the seller maintains the cost of the homeowners insurance is current on property taxes and keeps the property maintained. This allows the seller additional time to recover. Once property is sold, if there are any proceeds over seller's mortgage, the proceeds will be given to seller for his/her cooperation.

User interface employing integrated marketing software system may also be configured to display mortgage merger forms and information. Homes and properties may have multiple liens. Normally, through the short sale or foreclosure process, most second and third mortgages are reduced to pennies on the dollar in comparison to the original loan amounts. The Mortgage Merger Form places second and third mortgages in first position, making payments to such junior liens mandatory and equally represented in the foreclosure or short sales.

For example, Seller has three outstanding loans attached to their home. The first mortgage A is $95,000, the second mortgage B is $60,000, and there is a personal mortgage C in the amount $25,000. In our current system, when the mortgage company that has Loan A forecloses on the mortgage, mortgage company B and C are forced to settle to $1,000 dollars per loan. The Mortgage Merger Form is created to add the junior liens to the first position mortgage. During a foreclosure or sale proceeding, loan B and C will be given a larger return.

Integrated marketing software system may also be configured as a communication tool between real estate investors and other parties pertinent to the sale of homes and real estate. User interface may be adapted to allow potential investors to securely communicate and seek potential investment opportunities.

For example, a vacant property has a delinquent mortgage amount of $50,000. The Increase In Value Analysis (IIVA) report stated it needed $15,000 in repairs, which would bring value to $135,000. The delinquent mortgage amount is not current market value. Trusted growth group members (2 to a group) paid 25,000 apiece for this property, but no money for repairs upfront. The cost of repairs will be paid out of the closing. Total cost of property to growth group=$50,000+$15,000(IIVA)=$65,000. The purchase price of $135,000 will show a return of the investment to each member of $32,500, a 30% return on initial investment. This is a trusted investment strategy. Trusted growth groups should pay no capital gains taxes under certain conditions. Support from the government on waiving these taxes will help stimulate investment.

What is claimed is:

1. A distributed computer hardware apparatus for financing a car and a home comprising:
a plurality of real estate listing record objects, each of said real estate listing record objects including a plurality of values, including at least one minimum acceptable offer value and an allocated automobile credit value;
a user interface configured to accept user search criteria to create at least one user search record object for real estate listings and a listing search processor to match said real estate listings to said user criteria;
at least one updated user interface which displays at least one said real estate listing having a value which matches least one of said user search criteria real estate listing record objects which meet said user criteria, said processor further configured to associate an allocated automobile credit value with each of said real estate listings;
at least one database of real estate transaction forms record objects, each of said real estate transaction form record configured to receive user entered financial values;
at least one processor which creates at least one user transaction form to create at least one real estate offer event object, said real estate offer event object having at least one value which is capable of being modified using said at least one user entered financial values;
at least one processor which receives said values which a user enters into said real estate transaction form field to complete an offer submission event which updates an available credit value; and
at least one automobile display object which displays an available automobile when said available credit amount is positive.

2. The apparatus of claim 1, which further includes at least one user record object containing quasi-unique identifying data about at least one user.

3. The apparatus of claim 1, which further includes at least one lender record object containing quasi-unique identifying data about at least one lender.

4. A method for approving an automobile purchase credit value consisting of:
obtaining a user input value;
matching said user input offer value to a minimum acceptable price value to generate an offer event record object; and
invoking a function which calculates an allocated automobile value credit.
